(19) United States
(12) Patent Application Publication
(10) Pub. No.: US 2025/0145866 A1
(43) Pub. Date: May 8, 2025

(54) AEROGEL-BASED LAYER, COMPOSITE MATERIAL, AND ADHESIVE TAPE

(71) Applicant: SAINT-GOBAIN PERFORMANCE PLASTICS CORPORATION, Solon, OH (US)

(72) Inventors: Chuanping LI, Shrewsbury, MA (US); Shuai LIANG, Southborough, MA (US); Katherine E. POKHREL, Framingham, MA (US); Fei WANG, Winchester, MA (US)

(21) Appl. No.: 18/936,498

(22) Filed: Nov. 4, 2024

Related U.S. Application Data
(60) Provisional application No. 63/596,374, filed on Nov. 6, 2023.

(51) Int. Cl. C09J 7/30; C09J 11/04

(52) U.S. Cl. CPC C09J 7/30; C09J 11/04; C09J 2301/408

(57) ABSTRACT

The present disclosure relates to an aerogel-based layer may include a silicone-based binder component at a content of at least about 10 wt. % and not greater than about 90 wt. % for a total weight of the aerogel-based layer, and an aerogel component at a content of at least about 10 wt. % and not greater than about 90 wt. % for a total weight of the aerogel-based layer.

### CROSS-REFERENCE TO RELATED APPLICATION(S)

This Application claims priority under 35 U.S.C. § 119(e) to U.S. Provisional Patent Application No. 63/596,374, entitled “AEROGEL-BASED LAYER, COMPOSITE MATERIAL, AND ADHESIVE TAPE,” by Chuanping L I et al., filed Nov. 6, 2023, which is assigned to the current assignee hereof and is incorporated herein by reference in its entirety.

### FIELD OF THE DISCLOSURE

The present disclosure relates to an aerogel-based layer, a composite material including an adhesive layer and an adhesive tape including an aerogel-based layer.

### BACKGROUND

Adhesives, composite materials and adhesive tapes are used in various applications that require thermal conductivity and flexibility. Accordingly, adhesive with improved thermal conductivity and flexibility are desired.

### SUMMARY

According to a first aspect, an aerogel-based layer may include a silicone-based binder component at a content of at least about 10 wt. % and not greater than about 90 wt. % for a total weight of the aerogel-based layer, and an aerogel component at a content of at least about 10 wt. % and not greater than about 90 wt. % for a total weight of the aerogel-based layer.

According to yet another aspect, a composite material may include a first substrate and an aerogel-based layer overlying a first surface of the first substrate. The aerogel-based layer may include a silicone-based binder component at a content of at least about 10 wt. % and not greater than about 90 wt. % for a total weight of the aerogel-based layer, and an aerogel component at a content of at least about 10 wt. % and not greater than about 90 wt. % for a total weight of the aerogel-based layer.

According to still another aspect, an adhesive tape may include a first substrate and an aerogel-based layer overlying a first surface of the first substrate. The aerogel-based layer may include a silicone-based binder component at a content of at least about 10 wt. % and not greater than about 90 wt. % for a total weight of the aerogel-based layer, and an aerogel component at a content of at least about 10 wt. % and not greater than about 90 wt. % for a total weight of the aerogel-based layer.

According to a still another aspect, a method of forming an aerogel-based layer may include providing a providing a mixture of a precursor silicone-based binder component and a precursor aerogel component, and forming the mixture into the aerogel-based layer. The aerogel-based layer may include a silicone-based binder component at a content of at least about 10 wt. % and not greater than about 90 wt. % for a total weight of the aerogel-based layer, and an aerogel component at a content of at least about 10 wt. % and not greater than about 90 wt. % for a total weight of the aerogel-based layer.

According to yet another aspect, a method of forming a composite material may include providing a first substrate, providing a mixture of a precursor silicone-based binder component and a precursor aerogel component, and forming the mixture into the aerogel-based layer overlying a first surface of the first substrate. The aerogel-based layer may include a silicone-based binder component at a content of at least about 10 wt. % and not greater than about 90 wt. % for a total weight of the aerogel-based layer, and an aerogel component at a content of at least about 10 wt. % and not greater than about 90 wt. % for a total weight of the aerogel-based layer.

According to still another aspect, a method of forming an adhesive tape may include providing a first substrate, providing a mixture of a precursor silicone-based binder component and a precursor aerogel component, and forming the mixture into the aerogel-based layer overlying a first surface of the first substrate. The aerogel-based layer may include a silicone-based binder component at a content of at least about 10 wt. % and not greater than about 90 wt. % for a total weight of the aerogel-based layer, and an aerogel component at a content of at least about 10 wt. % and not greater than about 90 wt. % for a total weight of the aerogel-based layer.

### BRIEF DESCRIPTION OF THE DRAWINGS

Embodiments are illustrated by way of example and are not limited to the accompanying figures.

FIG. 1 includes a diagram showing an adhesive layer forming method according to embodiments described herein;

FIG. 2 includes an illustration showing the configuration of an adhesive layer formed according to embodiments described herein;

FIG. 3 includes a diagram showing a composite material forming method according to embodiments described herein;

FIG. 4 includes an illustration showing the configuration of a composite material formed according to embodiments described herein.

FIG. 5 includes a diagram showing an adhesive tape forming method according to embodiments described herein; and

FIG. 6 includes an illustration showing the configuration of an adhesive tape formed according to embodiments described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to an adhesive layer that may include a silicone-based binder component and an aerogel component.

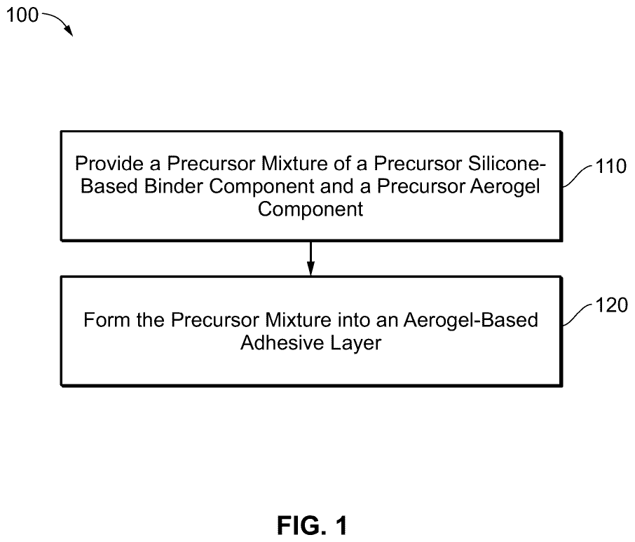

Referring first to a method of forming an aerogel-based layer, FIG. 1 includes a diagram showing a forming method 100 for forming an aerogel-based layer according to embodiments described herein. According to particular embodiments, the forming method 100 may include a first step 110 of providing a precursor mixture of a precursor silicone-based binder component and a precursor aerogel component, and a second step 120 of forming the precursor mixture into an aerogel-based layer.

According to particular embodiments, the precursor mixture may include a particular content of the precursor silicone-based binder component. For example, the precursor mixture may include a precursor silicone-based binder component content of at least about 10.0 wt. % for a total weight of the precursor mixture, such as, at least about 15.0 wt. % or at least about 20.0 wt. % or at least about 25.0 wt. % or at least about 30.0 wt. % or at least about 35.0 wt. % or at least about 40.0 wt. % or even at least about 45.0 wt. %. According to still other embodiments, the precursor mixture may include a precursor silicone-based binder component content of not greater than about 90.0 wt. % for a total weight of the precursor mixture, such as, not greater than about 85.0 wt. % or not greater than about 80.0 wt. % or not greater than about 75.0 wt. % or not greater than about 70.0 wt. % or not greater than about 65.0 wt. % or not greater than about 60.0 wt. % or even not greater than about 55.0 wt. %. It will be appreciated that the precursor mixture may include a precursor silicone-based binder component content of any value between, and including, any of the minimum and maximum values noted above. It will be further appreciated that the precursor mixture may include a precursor silicone-based binder component content within a range between, and including, any of the minimum and maximum values noted above.

According to particular embodiments, the precursor mixture may include a particular content of the precursor aerogel component. For example, the precursor mixture may include a precursor aerogel component content of at least about 10.0 wt. % for a total weight of the precursor mixture, such as, at least about 15.0 wt. % or at least about 20.0 wt. % or at least about 25.0 wt. % or at least about 30.0 wt. % or at least about 35.0 wt. % or at least about 40.0 wt. % or even at least about 45.0 wt. %. According to still other embodiments, the precursor mixture may include a precursor aerogel component content of not greater than about 90.0 wt. % for a total weight of the precursor mixture, such as, not greater than about 85.0 wt. % or not greater than about 80.0 wt. % or not greater than about 75.0 wt. % or not greater than about 70.0 wt. % or not greater than about 65.0 wt. % or not greater than about 60.0 wt. % or even not greater than about 55.0 wt. %. It will be appreciated that the precursor mixture may include a precursor aerogel component content of any value between, and including, any of the minimum and maximum values noted above. It will be further appreciated that the precursor mixture may include a precursor aerogel component content within a range between, and including, any of the minimum and maximum values noted above.

According to still other embodiments, the precursor mixture may further include an alkali silicate component. According to still other embodiments, the precursor mixture may include a particular precursor alkali silicate component content. For example, the precursor mixture may include a precursor alkali silicate component content of at least about 0.01 wt. % for a total weight of the precursor mixture, such as, at least about 0.05 wt. % or at least about 0.1 wt. % or at least about 0.2 wt. % or at least about 0.3 wt. % or at least about 0.4 wt. % or at least about 0.5 wt. % or at least about 0.75 wt. % or at least about 1.0 wt. % or at least about 1.25 wt. % or at least about 1.5 wt. % or at least about 1.75 wt. % or at least about 2.0 wt. % or at least about 2.25 wt. % or even at least about 2.5 wt. %. According to still other embodiments, the precursor mixture may include a precursor alkali silicate component content of not greater than about 4.0 wt. % for a total weight of the precursor mixture, such as, not greater than about 3.75 wt. % or not greater than about 3.50 wt. % or not greater than about 3.25 wt. % or not greater than about 3.0 wt. % or even not greater than about 2.75 wt. %. It will be appreciated that the precursor mixture may include a precursor alkali silicate component content of any value between, and including, any of the minimum and maximum values noted above. It will be further appreciated that the precursor mixture may include a precursor alkali silicate component content within a range between, and including, any of the minimum and maximum values noted above.

According to particular embodiments, the alkali silicate component may be a potassium silicate component. According to yet other embodiments, the alkali silicate component may be a sodium silicate component. According to other embodiments, the alkali silicate component may be any combination of a potassium silicate component and a sodium silicate component.

According to still other embodiments, the precursor mixture may further include a precursor thermal stabilizer component. According to certain embodiments the precursor thermal stabilizer component may include platinum compounds, transition metal oxides, calcium silicates, calcium carbonates, aluminum silicates, clay, mineral powders, iron salts of carboxylic acids, acids, metal hydrates, borate compounds, platinum compounds, transition metal oxides, metal carbonates, aluminum silicates, hydrous sodium silicate, glass frits, alkaline salts, vermiculites, ATH, borax, boron nitride, SSOH, POSS, Rosin derivates, magnesium silicates, magnesium carbonates, magnesium phosphates, magnesium hydroxides, superabsorbent polymers, waterglass, ammonium nitrate, zinc borate, zinc oxides, zirconium oxides, titanium oxides, silicon oxides, montmorillonite, superabsorbent polymers, cerium-containing compounds, iron-containing compounds, aluminum-containing compounds, carbon nanomaterials, or any combination thereof. According to yet other embodiments, the precursor thermal stabilizer may be a thermally stable shape filler, such as, a high aspect ratio filler. For example, the thermal stabilizer may have a needle shape, a platelet shape, a fiber shape or any combination thereof.

According to still other embodiments, the precursor mixture may include a particular precursor thermal stabilizer component content. For example, the precursor mixture may include a precursor thermal stabilizer component content of at least about 0.01 wt. % for a total weight of the precursor mixture, such as, at least about 0.05 wt. % or at least about 0.1 wt. % or at least about 0.5 wt. % or at least about 1.0 wt. % or at least about 2.5 wt. % or at least about 5.0 wt. % or at least about 7.5 wt. % or at least about 10.0 wt. % or at least about 12.5 wt. % or even at least about 15.0 wt. %. According to still other embodiments, the precursor mixture may include a precursor thermal stabilizer component content of not greater than about 30.0 wt. % for a total weight of the precursor mixture, such as, not greater than about 27.5 wt. % or not greater than about 25.0 wt. % or not greater than about 22.5 wt. % or not greater than about 20.0 wt. % or even not greater than about 17.5 wt. %. It will be appreciated that the precursor mixture may include a precursor thermal stabilizer component content of any value between, and including, any of the minimum and maximum values noted above. It will be further appreciated that the precursor mixture may include a precursor thermal stabilizer component content within a range between, and including, any of the minimum and maximum values noted above.

According to still other embodiments, the precursor mixture may further include a precursor opacifier filler. According to certain embodiments, the precursor opacifier filler may include silicon carbide, titanium dioxide, carbon black, graphite, zirconium dioxide, zirconium silicate, heavy metal oxides, zinc oxide, tin oxide, manganese oxide, nickel oxide, titanium carbide, tungsten carbide, iron oxide, ilmenite, silicon, silicon dioxide, aluminum, aluminum oxide, alumina, clay, metallic and nonmetallic particles, fibers, pigments, or any combination thereof.

According to still other embodiments, the precursor mixture may include a particular precursor opacifier filler content. For example, the precursor mixture may include a precursor opacifier filler content of at least about 0.01 wt. % for a total weight of the precursor mixture, such as, at least about 0.05 wt. % or at least about 0.1 wt. % or at least about 0.5 wt. % or at least about 1.0 wt. % or at least about 2.5 wt. % or at least about 5.0 wt. % or at least about 7.5 wt. % or at least about 10.0 wt. % or at least about 12.5 wt. % or even at least about 15.0 wt. %. According to still other embodiments, the precursor mixture may include a precursor opacifier filler content of not greater than about 30.0 wt. % for a total weight of the precursor mixture, such as, not greater than about 27.5 wt. % or not greater than about 25.0 wt. % or not greater than about 22.5 wt. % or not greater than about 20.0 wt. % or even not greater than about 17.5 wt. %. It will be appreciated that the precursor mixture may include a precursor opacifier filler content of any value between, and including, any of the minimum and maximum values noted above. It will be further appreciated that the precursor mixture may include a precursor opacifier filler content within a range between, and including, any of the minimum and maximum values noted above.

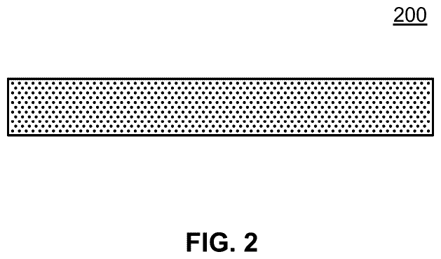

Referring now to embodiments of the aerogel-based layer formed according to forming method 100, FIG. 2 includes diagram of an aerogel-based layer 200. As shown in FIG. 2, the aerogel-based layer 200 may include a silicone-based binder component and an aerogel component.

According to particular embodiments, the aerogel-based layer 200 may have a particular shrinkage rating as measured at a firing temperature of 1000° C. For purposes or embodiments described herein, the shrinkage rating is measured according to a shrinkage test method where 1) before sintering, a picture of a sample of the aerogel-based layer is taken, and the dimensions are measured, 2) the sample is fired on a crucible to 1000° C. with a ramp rate of 10° C./min and held for 0.2 hrs before free cooling to room temperature, and 3) after the sample is fired, another picture of the sample is taken, and dimensions are measured. According to certain embodiments, the aerogel-based layer 200 may have a shrinkage rating of not greater than about 10%, such as, not greater than about 9% or not greater than about 8% or not greater than about 7% or not greater than about 6% or not greater than about 5% or not greater than about 4% or not greater than about 3% or not greater than about 2% or even not greater than about 1%. It will be appreciated that the aerogel-based layer 200 may have a shrinkage rating of any value between, and including, any of the values noted above. It will be further appreciated that the aerogel-based layer 200 may include a shrinkage rating a range between, and including, any of the values noted above.

According to particular embodiments, the aerogel-based layer 200 may have a particular thermal conductivity as measured according to ASTM C518. According to certain embodiments, the aerogel-based layer 200 may have a thermal conductivity of not greater than about 0.05 W/m-K, such as, not greater than about 0.045 W/m-K or not greater than about 0.04 W/m-K or not greater than about 0.035 W/m-K or not greater than about 0.03 W/m-K or not greater than about 0.025 W/m-K or even not greater than about 0.01 W/m-K. It will be appreciated that the aerogel-based layer 200 may have a thermal conductivity of any value between, and including, any of the values noted above. It will be further appreciated that the aerogel-based layer 200 may include a thermal conductivity a range between, and including, any of the values noted above.

According to particular embodiments, the aerogel-based layer 200 may include a particular content of the silicone-based binder component. For example, the aerogel-based layer 200 may include a silicone-based binder component content of at least about 10.0 wt. % for a total weight of the aerogel-based layer 200, such as, at least about 15.0 wt. % or at least about 20.0 wt. % or at least about 25.0 wt. % or at least about 30.0 wt. % or at least about 35.0 wt. % or at least about 40.0 wt. % or even at least about 45.0 wt. %. According to still other embodiments, the aerogel-based layer 200 may include a silicone-based binder component content of not greater than about 90.0 wt. % for a total weight of the aerogel-based layer 200, such as, not greater than about 85.0 wt. % or not greater than about 80.0 wt. % or not greater than about 75.0 wt. % or not greater than about 70.0 wt. % or not greater than about 65.0 wt. % or not greater than about 60.0 wt. % or even not greater than about 55.0 wt. %. It will be appreciated that the aerogel-based layer 200 may include a silicone-based binder component content of any value between, and including, any of the minimum and maximum values noted above. It will be further appreciated that the aerogel-based layer 200 may include a silicone-based binder component content within a range between, and including, any of the minimum and maximum values noted above.

According to particular embodiments, the aerogel-based layer 200 may include a particular content of the aerogel component. For example, the aerogel-based layer 200 may include an aerogel component content of at least about 10.0 wt. % for a total weight of the aerogel-based layer 200, such as, at least about 15.0 wt. % or at least about 20.0 wt. % or at least about 25.0 wt. % or at least about 30.0 wt. % or at least about 35.0 wt. % or at least about 40.0 wt. % or even at least about 45.0 wt. %. According to still other embodiments, the aerogel-based layer 200 may include an aerogel component content of not greater than about 90.0 wt. % for a total weight of the aerogel-based layer 200, such as, not greater than about 85.0 wt. % or not greater than about 80.0 wt. % or not greater than about 75.0 wt. % or not greater than about 70.0 wt. % or not greater than about 65.0 wt. % or not greater than about 60.0 wt. % or even not greater than about 55.0 wt. %. It will be appreciated that the aerogel-based layer 200 may include an aerogel component content of any value between, and including, any of the minimum and maximum values noted above. It will be further appreciated that the aerogel-based layer 200 may include an aerogel component content within a range between, and including, any of the minimum and maximum values noted above.

According to still other embodiments, the aerogel-based layer 200 may further include an alkali silicate component. According to still other embodiments, the aerogel-based layer 200 may include a particular alkali silicate component content. For example, the aerogel-based layer 200 may include an alkali silicate component content of at least about 0.01 wt. % for a total weight of the aerogel-based layer 200, such as, at least about 0.05 wt. % or at least about 0.1 wt. % or at least about 0.2 wt. % or at least about 0.3 wt. % or at least about 0.4 wt. % or at least about 0.5 wt. % or at least about 0.75 wt. % or at least about 1.0 wt. % or at least about 1.25 wt. % or at least about 1.5 wt. % or at least about 1.75 wt. % or at least about 2.0 wt. % or at least about 2.25 wt. % or even at least about 2.5 wt. %. According to still other embodiments, the aerogel-based layer 200 may include an alkali silicate component content of not greater than about 4.0 wt. % for a total weight of the aerogel-based layer 200, such as, not greater than about 3.75 wt. % or not greater than about 3.50 wt. % or not greater than about 3.25 wt. % or not greater than about 3.0 wt. % or even not greater than about 2.75 wt. %. It will be appreciated that the aerogel-based layer 200 may include an alkali silicate component content of any value between, and including, any of the minimum and maximum values noted above. It will be further appreciated that the aerogel-based layer 200 may include an alkali silicate component content within a range between, and including, any of the minimum and maximum values noted above.

According to particular embodiments, the alkali silicate component may be a potassium silicate component. According to yet other embodiments, the alkali silicate component may be a sodium silicate component. According to other embodiments, the alkali silicate component may be any combination of a potassium silicate component and a sodium silicate component.

According to still other embodiments, the aerogel-based layer 200 may further include a thermal stabilizer component. According to certain embodiments the thermal stabilizer component may include platinum compounds, transition metal oxides, calcium silicates, calcium carbonates, aluminum silicates, clay, mineral powders, iron salts of carboxylic acids, acids, metal hydrates, borate compounds, platinum compounds, transition metal oxides, metal carbonates, aluminum silicates, hydrous sodium silicate, glass frits, alkaline salts, vermiculites, ATH, borax, boron nitride, SSOH, POSS, Rosin derivates, magnesium silicates, magnesium carbonates, magnesium phosphates, magnesium hydroxides, superabsorbent polymers, waterglass, ammonium nitrate, zinc borate, zinc oxides, zirconium oxides, titanium oxides, silicon oxides, montmorillonite, superabsorbent polymers, cerium-containing compounds, iron-containing compounds, aluminum-containing compounds, carbon nanomaterials, or any combination thereof. According to yet other embodiments, the precursor thermal stabilizer may be a thermally stable shape filler, such as, a high aspect ratio filler. For example, the thermal stabilizer may have a needle shape, a platelet shape, a fiber shape or any combination thereof.

According to still other embodiments, the aerogel-based layer 200 may include a particular thermal stabilizer component content. For example, the aerogel-based layer 200 may include a thermal stabilizer component content of at least about 0.01 wt. % for a total weight of the aerogel-based layer 200, such as, at least about 0.05 wt. % or at least about 0.1 wt. % or at least about 0.5 wt. % or at least about 1.0 wt. % or at least about 2.5 wt. % or at least about 5.0 wt. % or at least about 7.5 wt. % or at least about 10.0 wt. % or at least about 12.5 wt. % or even at least about 15.0 wt. %. According to still other embodiments, the aerogel-based layer 200 may include a thermal stabilizer component content of not greater than about 30.0 wt. % for a total weight of the aerogel-based layer 200, such as, not greater than about 27.5 wt. % or not greater than about 25.0 wt. % or not greater than about 22.5 wt. % or not greater than about 20.0 wt. % or even not greater than about 17.5 wt. %. It will be appreciated that the aerogel-based layer 200 may include a thermal stabilizer component content of any value between, and including, any of the minimum and maximum values noted above. It will be further appreciated that the aerogel-based layer 200 may include a thermal stabilizer component content within a range between, and including, any of the minimum and maximum values noted above.

According to still other embodiments, the aerogel-based layer 200 may further include an opacifier filler. According to certain embodiments, the opacifier filler may include silicon carbide, titanium dioxide, carbon black, graphite, zirconium dioxide, zirconium silicate, heavy metal oxides, zinc oxide, tin oxide, manganese oxide, nickel oxide, titanium carbide, tungsten carbide, iron oxide, ilmenite, silicon, silicon dioxide, aluminum, aluminum oxide, alumina, clay, metallic and nonmetallic particles, fibers, pigments, or any combination thereof.

According to still other embodiments, the aerogel-based layer 200 may include a particular opacifier filler content. For example, the aerogel-based layer 200 may include an opacifier filler content of at least about 0.01 wt. % for a total weight of the aerogel-based layer 200, such as, at least about 0.05 wt. % or at least about 0.1 wt. % or at least about 0.5 wt. % or at least about 1.0 wt. % or at least about 2.5 wt. % or at least about 5.0 wt. % or at least about 7.5 wt. % or at least about 10.0 wt. % or at least about 12.5 wt. % or even at least about 15.0 wt. %. According to still other embodiments, the aerogel-based layer 200 may include an opacifier filler content of not greater than about 30.0 wt. % for a total weight of the aerogel-based layer 200, such as, not greater than about 27.5 wt. % or not greater than about 25.0 wt. % or not greater than about 22.5 wt. % or not greater than about 20.0 wt. % or even not greater than about 17.5 wt. %. It will be appreciated that the aerogel-based layer 200 may include an opacifier filler content of any value between, and including, any of the minimum and maximum values noted above. It will be further appreciated that the aerogel-based layer 200 may include an opacifier filler content within a range between, and including, any of the minimum and maximum values noted above.

Turning now to embodiments of a composite material that may include an aerogel-based layer 200 as described herein. Such additional embodiments described herein may be generally directed to a composite material that may include a first substrate and an aerogel-based layer 200 overlying the first substrate layer. According to certain embodiments, the aerogel-based layer 200 may include a silicone-based binder component and an aerogel component.

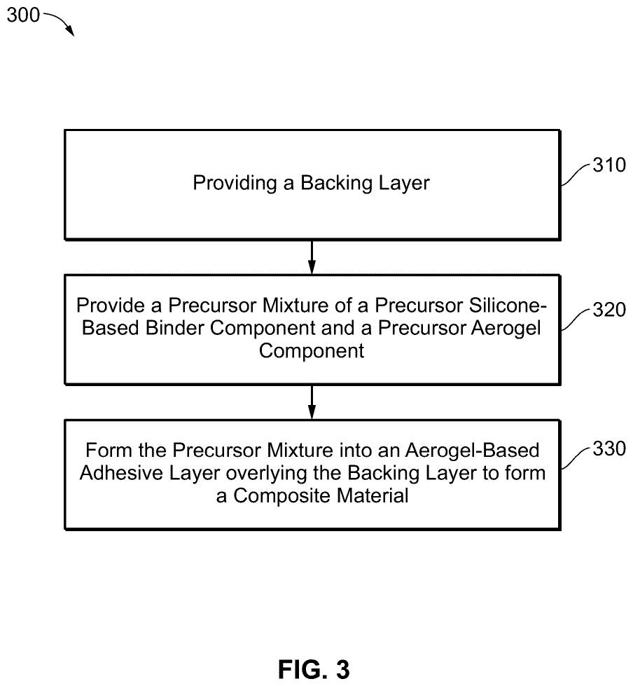

Referring next to a method of forming a composite material, FIG. 3 includes a diagram showing a forming method 300 for forming a composite material according to embodiments described herein. According to particular embodiments, the forming method 300 may include a first step 310 of providing a first substrate, a second step 320 of providing a precursor mixture of a precursor silicone-based binder component and a precursor aerogel component, and a third step 330 of forming the precursor mixture into an aerogel-based layer overlying a first surface of the first substrate.

According to still other embodiments, the first substrate may include cloth, vulcanized fiber, paper, fibrous reinforced thermoplastic substrate, polymeric films, substrates containing hooked stems, looped fabrics, metal foils, mesh, foam substrates, and laminated multilayer combinations thereof. Cloth substrates can be untreated, saturated, pre-sized, backsized, porous, or sealed, and they may be woven or stitch bonded. The cloth substrates may include fibers or yarns of cotton, polyester, rayon, silk, nylon or blends thereof. The cloth substrates can be provided as laminates with different substrate materials described herein. Paper substrates also can be saturated, barrier coated, pre-sized, backsized, untreated, or fiber-reinforced. The paper substrates also can be provided as laminates with a different type of substrate material. Polymeric substrates include polyolefin or polyester films. The polymeric substrates can be provided as blown film, or as laminates of different types of polymeric materials, or laminates of polymeric films with a non-polymeric type of substrate material. The substrate can also be a stem web used alone or incorporating a nonwoven, or as a laminate with a different type of substrate. The loop fabric substrate can be brushed nylon, brushed polyester, polyester stitched loop, and loop material laminated to a different type of substrate material. The foam substrate may be a natural sponge material or polyurethane foam and the like. The foam substrate also can be laminated to a different type of substrate material. The mesh substrates can be made of polymeric or metal open-weave scrims. According to still other embodiments, the first substrate may include a glass material, a wool material, a ceramic fabric material, a paper material, a fire-resistant paper material or any combination thereof.

According to particular embodiments, the precursor mixture may include a particular content of the precursor silicone-based binder component. For example, the precursor mixture may include a precursor silicone-based binder component content of at least about 10.0 wt. % for a total weight of the precursor mixture, such as, at least about 15.0 wt. % or at least about 20.0 wt. % or at least about 25.0 wt. % or at least about 30.0 wt. % or at least about 35.0 wt. % or at least about 40.0 wt. % or even at least about 45.0 wt. %. According to still other embodiments, the precursor mixture may include a precursor silicone-based binder component content of not greater than about 90.0 wt. % for a total weight of the precursor mixture, such as, not greater than about 85.0 wt. % or not greater than about 80.0 wt. % or not greater than about 75.0 wt. % or not greater than about 70.0 wt. % or not greater than about 65.0 wt. % or not greater than about 60.0 wt. % or even not greater than about 55.0 wt. %. It will be appreciated that the precursor mixture may include a precursor silicone-based binder component content of any value between, and including, any of the minimum and maximum values noted above. It will be further appreciated that the precursor mixture may include a precursor silicone-based binder component content within a range between, and including, any of the minimum and maximum values noted above.

According to particular embodiments, the precursor mixture may include a particular content of the precursor aerogel component. For example, the precursor mixture may include a precursor aerogel component content of at least about 10.0 wt. % for a total weight of the precursor mixture, such as, at least about 15.0 wt. % or at least about 20.0 wt. % or at least about 25.0 wt. % or at least about 30.0 wt. % or at least about 35.0 wt. % or at least about 40.0 wt. % or even at least about 45.0 wt. %. According to still other embodiments, the precursor mixture may include a precursor aerogel component content of not greater than about 90.0 wt. % for a total weight of the precursor mixture, such as, not greater than about 85.0 wt. % or not greater than about 80.0 wt. % or not greater than about 75.0 wt. % or not greater than about 70.0 wt. % or not greater than about 65.0 wt. % or not greater than about 60.0 wt. % or even not greater than about 55.0 wt. %. It will be appreciated that the precursor mixture may include a precursor aerogel component content of any value between, and including, any of the minimum and maximum values noted above. It will be further appreciated that the precursor mixture may include a precursor aerogel component content within a range between, and including, any of the minimum and maximum values noted above.

According to still other embodiments, the precursor mixture may further include an alkali silicate component. According to still other embodiments, the precursor mixture may include a particular precursor alkali silicate component content. For example, the precursor mixture may include a precursor alkali silicate component content of at least about 0.01 wt. % for a total weight of the precursor mixture, such as, at least about 0.05 wt. % or at least about 0.1 wt. % or at least about 0.2 wt. % or at least about 0.3 wt. % or at least about 0.4 wt. % or at least about 0.5 wt. % or at least about 0.75 wt. % or at least about 1.0 wt. % or at least about 1.25 wt. % or at least about 1.5 wt. % or at least about 1.75 wt. % or at least about 2.0 wt. % or at least about 2.25 wt. % or even at least about 2.5 wt. %. According to still other embodiments, the precursor mixture may include a precursor alkali silicate component content of not greater than about 4.0 wt. % for a total weight of the precursor mixture, such as, not greater than about 3.75 wt. % or not greater than about 3.50 wt. % or not greater than about 3.25 wt. % or not greater than about 3.0 wt. % or even not greater than about 2.75 wt. %. It will be appreciated that the precursor mixture may include a precursor alkali silicate component content of any value between, and including, any of the minimum and maximum values noted above. It will be further appreciated that the precursor mixture may include a precursor alkali silicate component content within a range between, and including, any of the minimum and maximum values noted above.

According to particular embodiments, the alkali silicate component may be a potassium silicate component. According to yet other embodiments, the alkali silicate component may be a sodium silicate component. According to other embodiments, the alkali silicate component may be any combination of a potassium silicate component and a sodium silicate component.

According to still other embodiments, the precursor mixture may further include a precursor thermal stabilizer component. According to certain embodiments the precursor thermal stabilize component may be include platinum compounds, transition metal oxides, calcium silicates, calcium carbonates, aluminum silicates, clay, mineral powders, iron salts of carboxylic acids, acids, metal hydrates, borate compounds, platinum compounds, transition metal oxides, metal carbonates, aluminum silicates, hydrous sodium silicate, glass frits, alkaline salts, vermiculites, ATH, borax, boron nitride, SSOH, POSS, Rosin derivates, magnesium silicates, magnesium carbonates, magnesium phosphates, magnesium hydroxides, superabsorbent polymers, waterglass, ammonium nitrate, zinc borate, zinc oxides, zirconium oxides, titanium oxides, silicon oxides, montmorillonite, superabsorbent polymers, cerium-containing compounds, iron-containing compounds, aluminum-containing compounds, carbon nanomaterials, or any combination thereof. According to yet other embodiments, the precursor thermal stabilizer may be a thermally stable shape filler, such as, a high aspect ratio filler. For example, the thermal stabilizer may have a needle shape, a platelet shape, a fiber shape or any combination thereof.

According to still other embodiments, the precursor mixture may include a particular precursor thermal stabilizer component content. For example, the precursor mixture may include a precursor thermal stabilizer component content of at least about 0.01 wt. % for a total weight of the precursor mixture, such as, at least about 0.05 wt. % or at least about 0.1 wt. % or at least about 0.5 wt. % or at least about 1.0 wt. % or at least about 2.5 wt. % or at least about 5.0 wt. % or at least about 7.5 wt. % or at least about 10.0 wt. % or at least about 12.5 wt. % or even at least about 15.0 wt. %. According to still other embodiments, the precursor mixture may include a precursor thermal stabilizer component content of not greater than about 30.0 wt. % for a total weight of the precursor mixture, such as, not greater than about 27.5 wt. % or not greater than about 25.0 wt. % or not greater than about 22.5 wt. % or not greater than about 20.0 wt. % or even not greater than about 17.5 wt. %. It will be appreciated that the precursor mixture may include a precursor thermal stabilizer component content of any value between, and including, any of the minimum and maximum values noted above. It will be further appreciated that the precursor mixture may include a precursor thermal stabilizer component content within a range between, and including, any of the minimum and maximum values noted above.

According to still other embodiments, the precursor mixture may further include a precursor opacifier filler. According to certain embodiments, the precursor opacifier filler may include silicon carbide, titanium dioxide, carbon black, graphite, zirconium dioxide, zirconium silicate, heavy metal oxides, zinc oxide, tin oxide, manganese oxide, nickel oxide, titanium carbide, tungsten carbide, iron oxide, ilmenite, silicon, silicon dioxide, aluminum, aluminum oxide, alumina, clay, metallic and nonmetallic particles, fibers, pigments, or any combination thereof.

According to still other embodiments, the precursor mixture may include a particular precursor opacifier filler content. For example, the precursor mixture may include a precursor opacifier filler content of at least about 0.01 wt. % for a total weight of the precursor mixture, such as, at least about 0.05 wt. % or at least about 0.1 wt. % or at least about 0.5 wt. % or at least about 1.0 wt. % or at least about 2.5 wt. % or at least about 5.0 wt. % or at least about 7.5 wt. % or at least about 10.0 wt. % or at least about 12.5 wt. % or even at least about 15.0 wt. %. According to still other embodiments, the precursor mixture may include a precursor opacifier filler content of not greater than about 30.0 wt. % for a total weight of the precursor mixture, such as, not greater than about 27.5 wt. % or not greater than about 25.0 wt. % or not greater than about 22.5 wt. % or not greater than about 20.0 wt. % or even not greater than about 17.5 wt. %. It will be appreciated that the precursor mixture may include a precursor opacifier filler content of any value between, and including, any of the minimum and maximum values noted above. It will be further appreciated that the precursor mixture may include a precursor opacifier filler content within a range between, and including, any of the minimum and maximum values noted above.

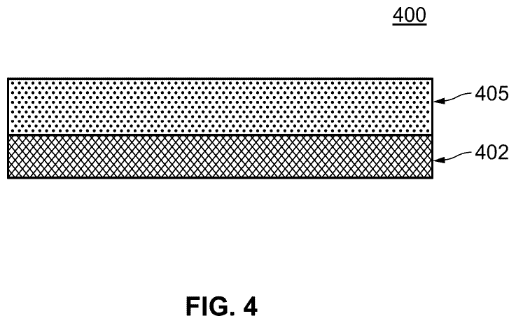

Referring now to embodiments of the composite material formed according to forming method 300, FIG. 4 includes a diagram of a composite material 400. As shown in FIG. 4, the composite material 400 may include a first substrate 402, and an aerogel-based layer 405 overlying a first surface of the first substrate 402. According to certain embodiments, the aerogel-based layer 405 may include a silicone-based binder component and an aerogel component.

According to particular embodiments, the composite material 400 may have a particular shrinkage rating as measured at a firing temperature of 1000° C. For purposes or embodiments described herein, the shrinkage rating is measured according to a shrinkage test method where 1) before sintering, a picture of a sample of the aerogel-based layer is taken, and the dimensions are measured, 2) the sample is fired on a crucible to 1000° C. with a ramp rate of 10° C./min and held for 0.2 hrs before free cooling to room temperature, and 3) after the sample is fired, another picture of the sample is taken, and dimensions are measured. According to certain embodiments, the composite material 400 may have a shrinkage rating of not greater than about 10%, such as, not greater than about 9% or not greater than about 8% or not greater than about 7% or not greater than about 6% or not greater than about 5% or not greater than about 4% or not greater than about 3% or not greater than about 2% or even not greater than about 1%. It will be appreciated that the composite material 400 may have a shrinkage rating of any value between, and including, any of the values noted above. It will be further appreciated that the composite material 400 may include a shrinkage rating a range between, and including, any of the values noted above.

According to particular embodiments, the composite material 400 may have a particular thermal conductivity as measured according to ASTM C518. According to certain embodiments, the composite material 400 may have a thermal conductivity of not greater than about 0.05 W/m-K, such as, not greater than about 0.045 W/m-K or not greater than about 0.04 W/m-K or not greater than about 0.035 W/m-K or not greater than about 0.03 W/m-K or not greater than about 0.025 W/m-K or even not greater than about 0.01 W/m-K. It will be appreciated that the composite material 400 may have a thermal conductivity of any value between, and including, any of the values noted above. It will be further appreciated that the composite material 400 may include a thermal conductivity in a range between, and including, any of the values noted above.

According to still other embodiments, the first substrate 402 may include cloth, vulcanized fiber, paper, fibrous reinforced thermoplastic substrate, polymeric films, substrates containing hooked stems, looped fabrics, metal foils, mesh, foam substrates, and laminated multilayer combinations thereof. Cloth substrates can be untreated, saturated, pre-sized, backsized, porous, or sealed, and they may be woven or stitch bonded. The cloth substrates may include fibers or yarns of cotton, polyester, rayon, silk, nylon or blends thereof. The cloth substrates can be provided as laminates with different substrate materials described herein. Paper substrates also can be saturated, barrier coated, pre-sized, backsized, untreated, or fiber-reinforced. The paper substrates also can be provided as laminates with a different type of substrate material. Polymeric substrates include polyolefin or polyester films. The polymeric substrates can be provided as blown film, or as laminates of different types of polymeric materials, or laminates of polymeric films with a non-polymeric type of substrate material. The substrate can also be a stem web used alone or incorporating a nonwoven, or as a laminate with a different type of substrate. The loop fabric substrate can be brushed nylon, brushed polyester, polyester stitched loop, and loop material laminated to a different type of substrate material. The foam substrate may be a natural sponge material or polyurethane foam and the like. The foam substrate also can be laminated to a different type of substrate material. The mesh substrates can be made of polymeric or metal open-weave scrims.

According to still other embodiments, the first substrate 402 may have a particular thickness. For example, the first substrate 402 may have a thickness of at least about 1 micron, such as, at least about 10 microns or at least about 20 microns or at least about 30 microns or at least about 40 microns or at least about 50 microns or at least about 60 microns or at least about 70 microns or at least about 80 microns or at least about 90 microns or at least about 100 microns or at least about 125 microns or at least about 150 microns or at least about 175 microns or at least about 200 microns or at least about 225 microns or even at least about 250 microns. According to still other embodiments, the first substrate 402 may have a thickness of not greater than about 500 microns, such as not greater than about 450 microns or not greater than about 400 microns or even not greater than about 350 microns. It will be appreciated that the first substrate 402 may have a thickness of any value between, and including, any of the minimum and maximum values noted above. It will be further appreciated that the first substrate 402 may have a thickness within a range between, and including, any of the minimum and maximum values noted above.

According to particular embodiments, the aerogel-based layer 405 may have a particular shrinkage rating as measured at a firing temperature of 1000° C. For purposes or embodiments described herein, the shrinkage rating is measured according to a shrinkage test method where 1) before sintering, a picture of a sample of the aerogel-based layer is taken, and the dimensions are measured, 2) the sample is fired on a crucible to 1000° C. with a ramp rate of 10° C./min and held for 0.2 hrs before free cooling to room temperature, and 3) after the sample is fired, another picture of the sample is taken, and dimensions are measured. According to certain embodiments, the aerogel-based layer 405 may have a shrinkage rating of not greater than about 10%, such as, not greater than about 9% or not greater than about 8% or not greater than about 7% or not greater than about 6% or not greater than about 5% or not greater than about 4% or not greater than about 3% or not greater than about 2% or even not greater than about 1%. It will be appreciated that the aerogel-based layer 405 may have a shrinkage rating of any value between, and including, any of the values noted above. It will be further appreciated that the aerogel-based layer 405 may include a shrinkage rating a range between, and including, any of the values noted above.

According to particular embodiments, the aerogel-based layer 405 may have a particular thermal conductivity as measured according to ASTM C518. According to certain embodiments, the aerogel-based layer 405 may have a thermal conductivity of not greater than about 0.05 W/m-K, such as, not greater than about 0.045 W/m-K or not greater than about 0.04 W/m-K or not greater than about 0.035 W/m-K or not greater than about 0.03 W/m-K or not greater than about 0.025 W/m-K or even not greater than about 0.01 W/m-K. It will be appreciated that the aerogel-based layer 405 may have a thermal conductivity of any value between, and including, any of the values noted above. It will be further appreciated that the aerogel-based layer 405 may include a thermal conductivity a range between, and including, any of the values noted above.

According to particular embodiments, the aerogel-based layer 405 may include a particular content of the silicone-based binder component. For example, the aerogel-based layer 405 may include a silicone-based binder component content of at least about 10.0 wt. % for a total weight of the aerogel-based layer 405, such as, at least about 15.0 wt. % or at least about 20.0 wt. % or at least about 25.0 wt. % or at least about 30.0 wt. % or at least about 35.0 wt. % or at least about 40.0 wt. % or even at least about 45.0 wt. %. According to still other embodiments, the aerogel-based layer 405 may include a silicone-based binder component content of not greater than about 90.0 wt. % for a total weight of the aerogel-based layer 405, such as, not greater than about 85.0 wt. % or not greater than about 80.0 wt. % or not greater than about 75.0 wt. % or not greater than about 70.0 wt. % or not greater than about 65.0 wt. % or not greater than about 60.0 wt. % or even not greater than about 55.0 wt. %. It will be appreciated that the aerogel-based layer 405 may include a silicone-based binder component content of any value between, and including, any of the minimum and maximum values noted above. It will be further appreciated that the aerogel-based layer 405 may include a silicone-based binder component content within a range between, and including, any of the minimum and maximum values noted above.

According to particular embodiments, the aerogel-based layer 405 may include a particular content of the aerogel component. For example, the aerogel-based layer 405 may include an aerogel component content of at least about 10.0 wt. % for a total weight of the aerogel-based layer 405, such as, at least about 15.0 wt. % or at least about 20.0 wt. % or at least about 25.0 wt. % or at least about 30.0 wt. % or at least about 35.0 wt. % or at least about 40.0 wt. % or even at least about 45.0 wt. %. According to still other embodiments, the aerogel-based layer 405 may include an aerogel component content of not greater than about 90.0 wt. % for a total weight of the aerogel-based layer 405, such as, not greater than about 85.0 wt. % or not greater than about 80.0 wt. % or not greater than about 75.0 wt. % or not greater than about 70.0 wt. % or not greater than about 65.0 wt. % or not greater than about 60.0 wt. % or even not greater than about 55.0 wt. %. It will be appreciated that the aerogel-based layer 405 may include an aerogel component content of any value between, and including, any of the minimum and maximum values noted above. It will be further appreciated that the aerogel-based layer 405 may include an aerogel component content within a range between, and including, any of the minimum and maximum values noted above.

According to still other embodiments, the aerogel-based layer 405 may further include an alkali silicate component. According to still other embodiments, the aerogel-based layer 405 may include a particular alkali silicate component content. For example, the aerogel-based layer 405 may include an alkali silicate component content of at least about 0.01 wt. % for a total weight of the aerogel-based layer 405, such as, at least about 0.05 wt. % or at least about 0.1 wt. % or at least about 0.2 wt. % or at least about 0.3 wt. % or at least about 0.4 wt. % or at least about 0.5 wt. % or at least about 0.75 wt. % or at least about 1.0 wt. % or at least about 1.25 wt. % or at least about 1.5 wt. % or at least about 1.75 wt. % or at least about 2.0 wt. % or at least about 2.25 wt. % or even at least about 2.5 wt. %. According to still other embodiments, the aerogel-based layer 405 may include an alkali silicate component content of not greater than about 4.0 wt. % for a total weight of the aerogel-based layer 405, such as, not greater than about 3.75 wt. % or not greater than about 3.50 wt. % or not greater than about 3.25 wt. % or not greater than about 3.0 wt. % or even not greater than about 2.75 wt. %. It will be appreciated that the aerogel-based layer 405 may include an alkali silicate component content of any value between, and including, any of the minimum and maximum values noted above. It will be further appreciated that the aerogel-based layer 405 may include an alkali silicate component content within a range between, and including, any of the minimum and maximum values noted above.

According to particular embodiments, the alkali silicate component may be a potassium silicate component. According to yet other embodiments, the alkali silicate component may be a sodium silicate component. According to other embodiments, the alkali silicate component may be any combination of a potassium silicate component and a sodium silicate component.

According to still other embodiments, the aerogel-based layer 405 may further include a thermal stabilizer component. According to certain embodiments the thermal stabilize component may include platinum compounds, transition metal oxides, calcium silicates, calcium carbonates, aluminum silicates, clay, mineral powders, iron salts of carboxylic acids, acids, metal hydrates, borate compounds, platinum compounds, transition metal oxides, metal carbonates, aluminum silicates, hydrous sodium silicate, glass frits, alkaline salts, vermiculites, ATH, borax, boron nitride, SSOH, POSS, Rosin derivates, magnesium silicates, magnesium carbonates, magnesium phosphates, magnesium hydroxides, superabsorbent polymers, waterglass, ammonium nitrate, zinc borate, zinc oxides, zirconium oxides, titanium oxides, silicon oxides, montmorillonite, superabsorbent polymers, cerium-containing compounds, iron-containing compounds, aluminum-containing compounds, carbon nanomaterials, or any combination thereof. According to yet other embodiments, the precursor thermal stabilizer may be a thermally stable shape filler, such as, a high aspect ratio filler. For example, the thermal stabilizer may have a needle shape, a platelet shape, a fiber shape or any combination thereof.

According to still other embodiments, the aerogel-based layer 405 may include a particular thermal stabilizer component content. For example, the aerogel-based layer 405 may include a thermal stabilizer component content of at least about 0.01 wt. % for a total weight of the aerogel-based layer 405, such as, at least about 0.05 wt. % or at least about 0.1 wt. % or at least about 0.5 wt. % or at least about 1.0 wt. % or at least about 2.5 wt. % or at least about 5.0 wt. % or at least about 7.5 wt. % or at least about 10.0 wt. % or at least about 12.5 wt. % or even at least about 15.0 wt. %. According to still other embodiments, the aerogel-based layer 405 may include a thermal stabilizer component content of not greater than about 30.0 wt. % for a total weight of the aerogel-based layer 405, such as, not greater than about 27.5 wt. % or not greater than about 25.0 wt. % or not greater than about 22.5 wt. % or not greater than about 20.0 wt. % or even not greater than about 17.5 wt. %. It will be appreciated that the aerogel-based layer 405 may include a thermal stabilizer component content of any value between, and including, any of the minimum and maximum values noted above. It will be further appreciated that the aerogel-based layer 405 may include a thermal stabilizer component content within a range between, and including, any of the minimum and maximum values noted above.

According to still other embodiments, the aerogel-based layer 405 may further include an opacifier filler. According to certain embodiments, the opacifier filler may be include silicon carbide, titanium dioxide, carbon black, graphite, zirconium dioxide, zirconium silicate, heavy metal oxides, zinc oxide, tin oxide, manganese oxide, nickel oxide, titanium carbide, tungsten carbide, iron oxide, ilmenite, silicon, silicon dioxide, aluminum, aluminum oxide, alumina, clay, metallic and nonmetallic particles, fibers, pigments, or any combination thereof.

According to still other embodiments, the aerogel-based layer 405 may include a particular opacifier filler content. For example, the aerogel-based layer 405 may include an opacifier filler content of at least about 0.01 wt. % for a total weight of the aerogel-based layer 405, such as, at least about 0.05 wt. % or at least about 0.1 wt. % or at least about 0.5 wt. % or at least about 1.0 wt. % or at least about 2.5 wt. % or at least about 5.0 wt. % or at least about 7.5 wt. % or at least about 10.0 wt. % or at least about 12.5 wt. % or even at least about 15.0 wt. %. According to still other embodiments, the aerogel-based layer 405 may include an opacifier filler content of not greater than about 30.0 wt. % for a total weight of the aerogel-based layer 405, such as, not greater than about 27.5 wt. % or not greater than about 25.0 wt. % or not greater than about 22.5 wt. % or not greater than about 20.0 wt. % or even not greater than about 17.5 wt. %. It will be appreciated that the aerogel-based layer 405 may include an opacifier filler content of any value between, and including, any of the minimum and maximum values noted above. It will be further appreciated that the aerogel-based layer 405 may include an opacifier filler content within a range between, and including, any of the minimum and maximum values noted above.

According to still other embodiments, the aerogel-based layer 405 may have a particular thickness. For example, the aerogel-based layer 405 may have a thickness of at least about 1 micron, such as, at least about 10 microns or at least about 20 microns or at least about 30 microns or at least about 40 microns or at least about 50 microns or at least about 60 microns or at least about 70 microns or at least about 80 microns or at least about 90 microns or at least about 100 microns or at least about 125 microns or at least about 150 microns or at least about 175 microns or at least about 200 microns or at least about 225 microns or at least about 250 microns or at least about 275 microns or at least about 300 microns or at least about 325 microns or at least about 350 microns or at least about 375 microns or at least about 400 microns or at least about 425 microns or at least about 450 microns or at least about 475 microns or even at least about 500 microns. According to still other embodiments, the aerogel-based layer 405 may have a thickness of not greater than about 1999 microns, such as not greater than about 1750 microns or not greater than about 1500 microns or not greater than about 1250 microns or not greater than about 1000 microns or even not greater than about 750 microns. It will be appreciated that the aerogel-based layer 605 may have a thickness of any value between, and including, any of the minimum and maximum values noted above. It will be appreciated that the aerogel-based layer 405 may have a thickness of any value between, and including, any of the minimum and maximum values noted above. It will be further appreciated that the aerogel-based layer 405 may have a thickness within a range between, and including, any of the minimum and maximum values noted above.

According to yet other alternative embodiments, the composite material 400 may further include a second substrate (not shown in FIG. 4). According to still other embodiments, the aerogel-based layer 405 may be located between the first substrate 402 and the second substrate.

According to still other embodiments, the second substrate may include cloth, vulcanized fiber, paper, fibrous reinforced thermoplastic substrate, polymeric films, substrates containing hooked stems, looped fabrics, metal foils, mesh, foam substrates, and laminated multilayer combinations thereof. Cloth substrates can be untreated, saturated, pre-sized, backsized, porous, or sealed, and they may be woven or stitch bonded. The cloth substrates may include fibers or yarns of cotton, polyester, rayon, silk, nylon or blends thereof. The cloth substrates can be provided as laminates with different substrate materials described herein. Paper substrates also can be saturated, barrier coated, pre-sized, backsized, untreated, or fiber-reinforced. The paper substrates also can be provided as laminates with a different type of substrate material. Polymeric substrates include polyolefin or polyester films. The polymeric substrates can be provided as blown film, or as laminates of different types of polymeric materials, or laminates of polymeric films with a non-polymeric type of substrate material. The substrate can also be a stem web used alone or incorporating a nonwoven, or as a laminate with a different type of substrate. The loop fabric substrate can be brushed nylon, brushed polyester, polyester stitched loop, and loop material laminated to a different type of substrate material. The foam substrate may be a natural sponge material or polyurethane foam and the like. The foam substrate also can be laminated to a different type of substrate material. The mesh substrates can be made of polymeric or metal open-weave scrims. According to still other embodiments, the second substrate may include a glass material, a wool material, a ceramic fabric material, a paper material, a fire resistant paper material or any combination thereof.

According to still other embodiments, the second substrate may have a particular thickness. For example, the second substrate may have a thickness of at least about 1 micron, such as, at least about 10 microns or at least about 20 microns or at least about 30 microns or at least about 40 microns or at least about 50 microns or at least about 60 microns or at least about 70 microns or at least about 80 microns or at least about 90 microns or at least about 100 microns or at least about 125 microns or at least about 150 microns or at least about 175 microns or at least about 200 microns or at least about 225 microns or even at least about 250 microns. According to still other embodiments, the second substrate may have a thickness of not greater than about 500 microns, such as not greater than about 450 microns or not greater than about 400 microns or even not greater than about 350 microns. It will be appreciated that the second substrate may have a thickness of any value between, and including, any of the minimum and maximum values noted above. It will be further appreciated that the second substrate may have a thickness within a range between, and including, any of the minimum and maximum values noted above.

Turning now to embodiments of an adhesive tape that may include an aerogel-based layer 200 as described herein. Such additional embodiments described herein may be generally directed to an adhesive tape that may include a first substrate and an aerogel-based layer 200 overlying the first substrate layer. According to certain embodiments, the aerogel-based layer 200 may include a silicone-based binder component and an aerogel component.

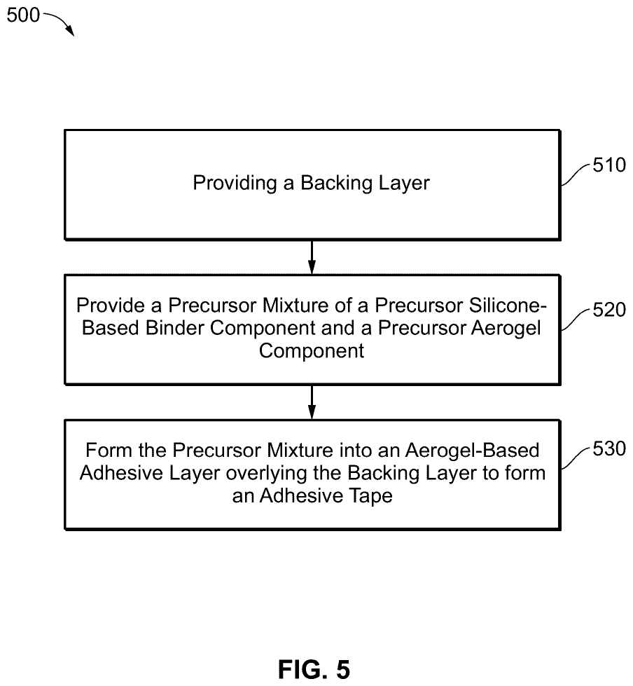

Referring next to a method of forming an adhesive tape, FIG. 5 includes a diagram showing a forming method 500 for forming an adhesive tape according to embodiments described herein. According to particular embodiments, the forming method 500 may include a first step 510 of providing a first substrate, a second step 520 of providing a precursor mixture of a precursor silicone-based binder component and a precursor aerogel component, and a third step 330 of forming the precursor mixture into an aerogel-based layer overlying a first surface of the first substrate.

According to still other embodiments, the first substrate may include cloth, vulcanized fiber, paper, fibrous reinforced thermoplastic substrate, polymeric films, substrates containing hooked stems, looped fabrics, metal foils, mesh, foam substrates, and laminated multilayer combinations thereof. Cloth substrates can be untreated, saturated, pre-sized, backsized, porous, or sealed, and they may be woven or stitch bonded. The cloth substrates may include fibers or yarns of cotton, polyester, rayon, silk, nylon or blends thereof. The cloth substrates can be provided as laminates with different substrate materials described herein. Paper substrates also can be saturated, barrier coated, pre-sized, backsized, untreated, or fiber-reinforced. The paper substrates also can be provided as laminates with a different type of substrate material. Polymeric substrates include polyolefin or polyester films. The polymeric substrates can be provided as blown film, or as laminates of different types of polymeric materials, or laminates of polymeric films with a non-polymeric type of substrate material. The substrate can also be a stem web used alone or incorporating a nonwoven, or as a laminate with a different type of substrate. The loop fabric substrate can be brushed nylon, brushed polyester, polyester stitched loop, and loop material laminated to a different type of substrate material. The foam substrate may be a natural sponge material or polyurethane foam and the like. The foam substrate also can be laminated to a different type of substrate material. The mesh substrates can be made of polymeric or metal open-weave scrims. According to still other embodiments, the first substrate may include a glass material, a wool material, a ceramic fabric material, a paper material, a fire-resistant paper material or any combination thereof.

According to particular embodiments, the precursor mixture may include a particular content of the precursor silicone-based binder component. For example, the precursor mixture may include a precursor silicone-based binder component content of at least about 10.0 wt. % for a total weight of the precursor mixture, such as, at least about 15.0 wt. % or at least about 20.0 wt. % or at least about 25.0 wt. % or at least about 30.0 wt. % or at least about 35.0 wt. % or at least about 40.0 wt. % or even at least about 45.0 wt. %. According to still other embodiments, the precursor mixture may include a precursor silicone-based binder component content of not greater than about 90.0 wt. % for a total weight of the precursor mixture, such as, not greater than about 85.0 wt. % or not greater than about 80.0 wt. % or not greater than about 75.0 wt. % or not greater than about 70.0 wt. % or not greater than about 65.0 wt. % or not greater than about 60.0 wt. % or even not greater than about 55.0 wt. %. It will be appreciated that the precursor mixture may include a precursor silicone-based binder component content of any value between, and including, any of the minimum and maximum values noted above. It will be further appreciated that the precursor mixture may include a precursor silicone-based binder component content within a range between, and including, any of the minimum and maximum values noted above.

According to particular embodiments, the precursor mixture may include a particular content of the precursor aerogel component. For example, the precursor mixture may include a precursor aerogel component content of at least about 10.0 wt. % for a total weight of the precursor mixture, such as, at least about 15.0 wt. % or at least about 20.0 wt. % or at least about 25.0 wt. % or at least about 30.0 wt. % or at least about 35.0 wt. % or at least about 40.0 wt. % or even at least about 45.0 wt. %. According to still other embodiments, the precursor mixture may include a precursor aerogel component content of not greater than about 90.0 wt. % for a total weight of the precursor mixture, such as, not greater than about 85.0 wt. % or not greater than about 80.0 wt. % or not greater than about 75.0 wt. % or not greater than about 70.0 wt. % or not greater than about 65.0 wt. % or not greater than about 60.0 wt. % or even not greater than about 55.0 wt. %. It will be appreciated that the precursor mixture may include a precursor aerogel component content of any value between, and including, any of the minimum and maximum values noted above. It will be further appreciated that the precursor mixture may include a precursor aerogel component content within a range between, and including, any of the minimum and maximum values noted above.

According to still other embodiments, the precursor mixture may further include an alkali silicate component. According to still other embodiments, the precursor mixture may include a particular precursor alkali silicate component content. For example, the precursor mixture may include a precursor alkali silicate component content of at least about 0.01 wt. % for a total weight of the precursor mixture, such as, at least about 0.05 wt. % or at least about 0.1 wt. % or at least about 0.2 wt. % or at least about 0.3 wt. % or at least about 0.4 wt. % or at least about 0.5 wt. % or at least about 0.75 wt. % or at least about 1.0 wt. % or at least about 1.25 wt. % or at least about 1.5 wt. % or at least about 1.75 wt. % or at least about 2.0 wt. % or at least about 2.25 wt. % or even at least about 2.5 wt. %. According to still other embodiments, the precursor mixture may include a precursor alkali silicate component content of not greater than about 4.0 wt. % for a total weight of the precursor mixture, such as, not greater than about 3.75 wt. % or not greater than about 3.50 wt. % or not greater than about 3.25 wt. % or not greater than about 3.0 wt. % or even not greater than about 2.75 wt. %. It will be appreciated that the precursor mixture may include a precursor alkali silicate component content of any value between, and including, any of the minimum and maximum values noted above. It will be further appreciated that the precursor mixture may include a precursor alkali silicate component content within a range between, and including, any of the minimum and maximum values noted above.

According to particular embodiments, the alkali silicate component may be a potassium silicate component. According to yet other embodiments, the alkali silicate component may be a sodium silicate component. According to other embodiments, the alkali silicate component may be any combination of a potassium silicate component and a sodium silicate component.

According to still other embodiments, the precursor mixture may further include a precursor thermal stabilizer component. According to certain embodiments the precursor thermal stabilize component may include platinum compounds, transition metal oxides, calcium silicates, calcium carbonates, aluminum silicates, clay, mineral powders, iron salts of carboxylic acids, acids, metal hydrates, borate compounds, platinum compounds, transition metal oxides, metal carbonates, aluminum silicates, hydrous sodium silicate, glass frits, alkaline salts, vermiculites, ATH, borax, boron nitride, SSOH, POSS, Rosin derivates, magnesium silicates, magnesium waterglass, ammonium nitrate, zinc borate, zinc oxides, zirconium oxides, titanium oxides, silicon oxides, montmorillonite, superabsorbent polymers, cerium-containing compounds, iron- containing compounds, aluminum-containing compounds, carbon nanomaterials, or any combination thereof. According to yet other embodiments, the precursor thermal stabilizer may be a thermally stable shape filler, such as, a high aspect ratio filler. For example, the thermal stabilizer may have a needle shape, a platelet shape, a fiber shape or any combination thereof.

According to still other embodiments, the precursor mixture may include a particular precursor thermal stabilizer component content. For example, the precursor mixture may include a precursor thermal stabilizer component content of at least about 0.01 wt. % for a total weight of the precursor mixture, such as, at least about 0.05 wt. % or at least about 0.1 wt. % or at least about 0.5 wt. % or at least about 1.0 wt. % or at least about 2.5wt. % or at least about 5.0 wt. % or at least about 7.5 wt. % or at least about 10.0 wt. % or at least about 12.5 wt. % or even at least about 15.0 wt. %. According to still other embodiments, the precursor mixture may include a precursor thermal stabilizer component content of not greater than about 30.0 wt. % for a total weight of the precursor mixture, such as, not greater than about 27.5 wt. % or not greater than about 25.0 wt. % or not greater than about 22.5 wt. % or not greater than about 20.0 wt. % or even not greater than about 17.5 wt. %. It will be appreciated that the precursor mixture may include a precursor thermal stabilizer component content of any value between, and including, any of the minimum and maximum values noted above. It will be further appreciated that the precursor mixture may include a precursor thermal stabilizer component content within a range between, and including, any of the minimum and maximum values noted above.

According to still other embodiments, the precursor mixture may further include a precursor opacifier filler. According to certain embodiments, the precursor opacifier filler may include silicon carbide, titanium dioxide, carbon black, graphite, zirconium dioxide, zirconium silicate, heavy metal oxides, zinc oxide, tin oxide, manganese oxide, nickel oxide, titanium carbide, tungsten carbide, iron oxide, ilmenite, silicon, silicon dioxide, aluminum, aluminum oxide, alumina, clay, metallic and nonmetallic particles, fibers, pigments, or any combination thereof.

According to still other embodiments, the precursor mixture may include a particular precursor opacifier filler content. For example, the precursor mixture may include a precursor opacifier filler content of at least about 0.01 wt. % for a total weight of the precursor mixture, such as, at least about 0.05 wt. % or at least about 0.1 wt. % or at least about 0.5 wt. % or at least about 1.0 wt. % or at least about 2.5 wt. % or at least about 5.0 wt. % or at least about 7.5 wt. % or at least about 10.0 wt. % or at least about 12.5 wt. % or even at least about 15.0 wt. %. According to still other embodiments, the precursor mixture may include a precursor opacifier filler content of not greater than about 30.0 wt. % for a total weight of the precursor mixture, such as, not greater than about 27.5 wt. % or not greater than about 25.0 wt. % or not greater than about 22.5 wt. % or not greater than about 20.0 wt. % or even not greater than about 17.5 wt. %. It will be appreciated that the precursor mixture may include a precursor opacifier filler content of any value between, and including, any of the minimum and maximum values noted above. It will be further appreciated that the precursor mixture may include a precursor opacifier filler content within a range between, and including, any of the minimum and maximum values noted above.

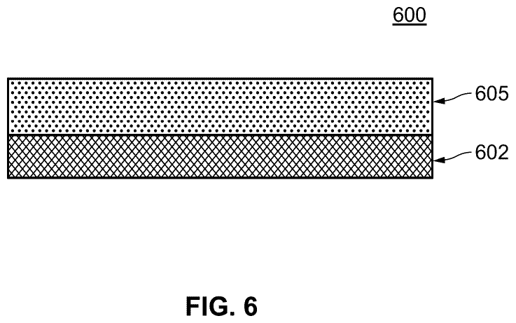

Referring now to embodiments of the adhesive tape formed according to forming method 500, FIG. 6 includes diagram of an adhesive tape 600. As shown in FIG. 6, the adhesive tape 600 may include a first substrate 602, and an aerogel-based layer 605 overlying a first surface of the first substrate 602. According to certain embodiments, the aerogel-based layer 605 may include a silicone-based binder component and an aerogel component.

According to particular embodiments, the adhesive tape 600 may have a particular shrinkage rating as measured at a firing temperature of 1000° C. For purposes or embodiments described herein, the shrinkage rating is measured according to a shrinkage test method where 1) before sintering, a picture of a sample of the aerogel-based layer is taken, and the dimensions are measured, 2) the sample is fired on a crucible to 1000° C. with a ramp rate of 10° C./min and held for 0.2 hrs before free cooling to room temperature, and 3) after the sample is fired, another picture of the sample is taken, and dimensions are measured. According to certain embodiments, the adhesive tape 600 may have a shrinkage rating of not greater than about 10%, such as, not greater than about 9% or not greater than about 8% or not greater than about 7% or not greater than about 6% or not greater than about 5% or not greater than about 4% or not greater than about 3% or not greater than about 2% or even not greater than about 1%. It will be appreciated that the adhesive tape 600 may have a shrinkage rating of any value between, and including, any of the values noted above. It will be further appreciated that the adhesive tape 600 may include a shrinkage rating a range between, and including, any of the values noted above.

According to particular embodiments, the adhesive tape 600 may have a particular thermal conductivity as measured according to ASTM C518. According to certain embodiments, the adhesive tape 600 may have a thermal conductivity of not greater than about 0.05 W/m-K, such as, not greater than about 0.045 W/m-K or not greater than about 0.04 W/m-K or not greater than about 0.035 W/m-K or not greater than about 0.03 W/m-K or not greater than about 0.025 W/m-K or even not greater than about 0.01 W/m-K. It will be appreciated that the adhesive tape 600 may have a thermal conductivity of any value between, and including, any of the values noted above. It will be further appreciated that the adhesive tape 600 may include a thermal conductivity a range between, and including, any of the values noted above.

According to still other embodiments, the first substrate 602 may include cloth, vulcanized fiber, paper, fibrous reinforced thermoplastic substrate, polymeric films, substrates containing hooked stems, looped fabrics, metal foils, mesh, foam substrates, and laminated multilayer combinations thereof. Cloth substrates can be untreated, saturated, pre-sized, backsized, porous, or sealed, and they may be woven or stitch bonded. The cloth substrates may include fibers or yarns of cotton, polyester, rayon, silk, nylon or blends thereof. The cloth substrates can be provided as laminates with different substrate materials described herein. Paper substrates also can be saturated, barrier coated, pre-sized, backsized, untreated, or fiber-reinforced. The paper substrates also can be provided as laminates with a different type of substrate material. Polymeric substrates include polyolefin or polyester films. The polymeric substrates can be provided as blown film, or as laminates of different types of polymeric materials, or laminates of polymeric films with a non-polymeric type of substrate material. The substrate can also be a stem web used alone or incorporating a nonwoven, or as a laminate with a different type of substrate. The loop fabric substrate can be brushed nylon, brushed polyester, polyester stitched loop, and loop material laminated to a different type of substrate material. The foam substrate may be a natural sponge material or polyurethane foam and the like. The foam substrate also can be laminated to a different type of substrate material. The mesh substrates can be made of polymeric or metal open-weave scrims.

According to still other embodiments, the first substrate 602 may have a particular thickness. For example, the first substrate 602 may have a thickness of at least about 1 micron, such as, at least about 10 microns or at least about 20 microns or at least about 30 microns or at least about 40 microns or at least about 50 microns or at least about 60 microns or at least about 70 microns or at least about 80 microns or at least about 90 microns or at least about 100 microns or at least about 125 microns or at least about 150 microns or at least about 175 microns or at least about 200 microns or at least about 225 microns or even at least about 250 microns. According to still other embodiments, the first substrate 602 may have a thickness of not greater than about 500 microns, such as not greater than about 450 microns or not greater than about 400 microns or even not greater than about 350 microns. It will be appreciated that the first substrate 602 may have a thickness of any value between, and including, any of the minimum and maximum values noted above. It will be further appreciated that the first substrate 602 may have a thickness within a range between, and including, any of the minimum and maximum values noted above.

According to particular embodiments, the aerogel-based layer 605 may have a particular shrinkage rating as measured at a firing temperature of 1000° C. For purposes or embodiments described herein, the shrinkage rating is measured according to a shrinkage test method where 1) before sintering, a picture of a sample of the aerogel-based layer is taken, and the dimensions are measured, 2) the sample is fired on a crucible to 1000° C. with a ramp rate of 10° C./min and held for 0.2 hrs before free cooling to room temperature, and 3) after the sample is fired, another picture of the sample is taken, and dimensions are measured. According to certain embodiments, the aerogel-based layer 605 may have a shrinkage rating of not greater than about 10%, such as, not greater than about 9% or not greater than about 8% or not greater than about 7% or not greater than about 6% or not greater than about 5% or not greater than about 4% or not greater than about 3% or not greater than about 2% or even not greater than about 1%. It will be appreciated that the aerogel-based layer 605 may have a shrinkage rating of any value between, and including, any of the values noted above. It will be further appreciated that the aerogel-based layer 605 may include a shrinkage rating a range between, and including, any of the values noted above.

According to particular embodiments, the aerogel-based layer 605 may have a particular thermal conductivity as measured according to ASTM C518. According to certain embodiments, the aerogel-based layer 605 may have a thermal conductivity of not greater than about 0.05 W/m-K, such as, not greater than about 0.045 W/m-K or not greater than about 0.04 W/m-K or not greater than about 0.035 W/m-K or not greater than about 0.03 W/m-K or not greater than about 0.025 W/m-K or even not greater than about 0.01 W/m-K. It will be appreciated that the aerogel-based layer 605 may have a thermal conductivity of any value between, and including, any of the values noted above. It will be further appreciated that the aerogel-based layer 605 may include a thermal conductivity a range between, and including, any of the values noted above.

According to particular embodiments, the aerogel-based layer 605 may include a particular content of the silicone-based binder component. For example, the aerogel-based layer 605 may include a silicone-based binder component content of at least about 10.0 wt. % for a total weight of the aerogel-based layer 605, such as, at least about 15.0 wt. % or at least about 20.0 wt. % or at least about 25.0 wt. % or at least about 30.0 wt. % or at least about 35.0 wt. % or at least about 40.0 wt. % or even at least about 45.0 wt. %. According to still other embodiments, the aerogel-based layer 605 may include a silicone-based binder component content of not greater than about 90.0 wt. % for a total weight of the aerogel-based layer 605, such as, not greater than about 85.0 wt. % or not greater than about 80.0 wt. % or not greater than about 75.0 wt. % or not greater than about 70.0 wt. % or not greater than about 65.0 wt. % or not greater than about 60.0 wt. % or even not greater than about 55.0 wt. %. It will be appreciated that the aerogel-based layer 605 may include a silicone-based binder component content of any value between, and including, any of the minimum and maximum values noted above. It will be further appreciated that the aerogel-based layer 605 may include a silicone-based binder component content within a range between, and including, any of the minimum and maximum values noted above.

According to particular embodiments, the aerogel-based layer 605 may include a particular content of the aerogel component. For example, the aerogel-based layer 605 may include an aerogel component content of at least about 10.0 wt. % for a total weight of the aerogel-based layer 605, such as, at least about 15.0 wt. % or at least about 20.0 wt. % or at least about 25.0 wt. % or at least about 30.0 wt. % or at least about 35.0 wt. % or at least about 40.0 wt. % or even at least about 45.0 wt. %. According to still other embodiments, the aerogel-based layer 605 may include an aerogel component content of not greater than about 90.0 wt. % for a total weight of the aerogel-based layer 605, such as, not greater than about 85.0 wt. % or not greater than about 80.0 wt. % or not greater than about 75.0 wt. % or not greater than about 70.0 wt. % or not greater than about 65.0 wt. % or not greater than about 60.0 wt. % or even not greater than about 55.0 wt. %. It will be appreciated that the aerogel-based layer 605 may include an aerogel component content of any value between, and including, any of the minimum and maximum values noted above. It will be further appreciated that the aerogel-based layer 605 may include an aerogel component content within a range between, and including, any of the minimum and maximum values noted above.

According to still other embodiments, the aerogel-based layer 605 may further include an alkali silicate component. According to still other embodiments, the aerogel-based layer 605 may include a particular alkali silicate component content. For example, the aerogel-based layer 605 may include an alkali silicate component content of at least about 0.01 wt. % for a total weight of the aerogel-based layer 605, such as, at least about 0.05 wt. % or at least about 0.1 wt. % or at least about 0.2 wt. % or at least about 0.3 wt. % or at least about 0.4 wt. % or at least about 0.5 wt. % or at least about 0.75 wt. % or at least about 1.0 wt. % or at least about 1.25 wt. % or at least about 1.5 wt. % or at least about 1.75 wt. % or at least about 2.0 wt. % or at least about 2.25 wt. % or even at least about 2.5 wt. %. According to still other embodiments, the aerogel-based layer 605 may include an alkali silicate component content of not greater than about 4.0 wt. % for a total weight of the aerogel-based layer 605, such as, not greater than about 3.75 wt. % or not greater than about 3.50 wt. % or not greater than about 3.25 wt. % or not greater than about 3.0 wt. % or even not greater than about 2.75 wt. %. It will be appreciated that the aerogel-based layer 605 may include an alkali silicate component content of any value between, and including, any of the minimum and maximum values noted above. It will be further appreciated that the aerogel-based layer 605 may include an alkali silicate component content within a range between, and including, any of the minimum and maximum values noted above.

According to particular embodiments, the alkali silicate component may be a potassium silicate component. According to yet other embodiments, the alkali silicate component may be a sodium silicate component. According to other embodiments, the alkali silicate component may be any combination of a potassium silicate component and a sodium silicate component.

According to still other embodiments, the aerogel-based layer 605 may further include a thermal stabilizer component. According to certain embodiments the thermal stabilize component may be include platinum compounds, transition metal oxides, calcium silicates, calcium carbonates, aluminum silicates, clay, mineral powders, iron salts of carboxylic acids, acids, metal hydrates, borate compounds, platinum compounds, transition metal oxides, metal carbonates, aluminum silicates, hydrous sodium silicate, glass frits, alkaline salts, vermiculites, ATH, borax, boron nitride, SSOH, POSS, Rosin derivates, magnesium silicates, magnesium waterglass, ammonium nitrate, zinc borate, zinc oxides, zirconium oxides, titanium oxides, silicon oxides, montmorillonite, superabsorbent polymers, cerium-containing compounds, iron- containing compounds, aluminum-containing compounds, carbon nanomaterials, or any combination thereof. According to yet other embodiments, the precursor thermal stabilizer may be a thermally stable shape filler, such as, a high aspect ratio filler. For example, the thermal stabilizer may have a needle shape, a platelet shape, a fiber shape or any combination thereof.

According to still other embodiments, the aerogel-based layer 605 may include a particular thermal stabilizer component content. For example, the aerogel-based layer 605 may include a thermal stabilizer component content of at least about 0.01 wt. % for a total weight of the aerogel-based layer 605, such as, at least about 0.05 wt. % or at least about 0.1 wt. % or at least about 0.5 wt. % or at least about 1.0 wt. % or at least about 2.5 wt. % or at least about 5.0 wt. % or at least about 7.5 wt. % or at least about 10.0 wt. % or at least about 12.5 wt. % or even at least about 15.0 wt. %. According to still other embodiments, the aerogel-based layer 605 may include a thermal stabilizer component content of not greater than about 30.0 wt. % for a total weight of the aerogel-based layer 605, such as, not greater than about 27.5 wt. % or not greater than about 25.0 wt. % or not greater than about 22.5 wt. % or not greater than about 20.0 wt. % or even not greater than about 17.5 wt. %. It will be appreciated that the aerogel-based layer 605 may include a thermal stabilizer component content of any value between, and including, any of the minimum and maximum values noted above. It will be further appreciated that the aerogel-based layer 605 may include a thermal stabilizer component content within a range between, and including, any of the minimum and maximum values noted above.

According to still other embodiments, the aerogel-based layer 605 may further include an opacifier filler. According to certain embodiments, the opacifier filler may be silicon carbide, titanium dioxide, carbon black, graphite, zirconium dioxide, zirconium silicate, heavy metal oxides, zinc oxide, tin oxide, manganese oxide, nickel oxide, titanium carbide, tungsten carbide, iron oxide, ilmenite, silicon, silicon dioxide, aluminum, aluminum oxide, alumina, clay, metallic and nonmetallic particles, fibers, pigments, or any combination thereof.

According to still other embodiments, the aerogel-based layer 605 may include a particular opacifier filler content. For example, the aerogel-based layer 605 may include an opacifier filler content of at least about 0.01 wt. % for a total weight of the aerogel-based layer 605, such as, at least about 0.05 wt. % or at least about 0.1 wt. % or at least about 0.5 wt. % or at least about 1.0 wt. % or at least about 2.5 wt. % or at least about 5.0 wt. % or at least about 7.5 wt. % or at least about 10.0 wt. % or at least about 12.5 wt. % or even at least about 15.0 wt. %. According to still other embodiments, the aerogel-based layer 605 may include an opacifier filler content of not greater than about 30.0 wt. % for a total weight of the aerogel-based layer 605, such as, not greater than about 27.5 wt. % or not greater than about 25.0 wt. % or not greater than about 22.5 wt. % or not greater than about 20.0 wt. % or even not greater than about 17.5 wt. %. It will be appreciated that the aerogel-based layer 605 may include an opacifier filler content of any value between, and including, any of the minimum and maximum values noted above. It will be further appreciated that the aerogel-based layer 605 may include an opacifier filler content within a range between, and including, any of the minimum and maximum values noted above.

According to still other embodiments, the aerogel-based layer 605 may have a particular thickness. For example, the aerogel-based layer 605 may have a thickness of at least about 1 micron, such as, at least about 10 microns or at least about 20 microns or at least about 30 microns or at least about 40 microns or at least about 50 microns or at least about 60 microns or at least about 70 microns or at least about 80 microns or at least about 90 microns or at least about 100 microns or at least about 125 microns or at least about 150 microns or at least about 175 microns or at least about 200 microns or at least about 225 microns or at least about 250 microns or at least about 275 microns or at least about 300 microns or at least about 325 microns or at least about 350 microns or at least about 375 microns or at least about 400 microns or at least about 425 microns or at least about 450 microns or at least about 475 microns or even at least about 500 microns. According to still other embodiments, the aerogel-based layer 605 may have a thickness of not greater than about 1999 microns, such as not greater than about 1750 microns or not greater than about 1500 microns or not greater than about 1250 microns or not greater than about 1000 microns or even not greater than about 750 microns. It will be appreciated that the aerogel-based layer 605 may have a thickness of any value between, and including, any of the minimum and maximum values noted above. It will be further appreciated that the aerogel-based layer 605 may have a thickness within a range between, and including, any of the minimum and maximum values noted above.

According to yet other alternative embodiments, the adhesive tape 600 may further include a second substrate (not shown in FIG. 6). According to still other embodiments, the aerogel-based layer 605 may be located between the first substrate 602 and the second substrate.

According to still other embodiments, the second substrate may include cloth, vulcanized fiber, paper, fibrous reinforced thermoplastic substrate, polymeric films, substrates containing hooked stems, looped fabrics, metal foils, mesh, foam substrates, and laminated multilayer combinations thereof. Cloth substrates can be untreated, saturated, pre-sized, backsized, porous, or sealed, and they may be woven or stitch bonded. The cloth substrates may include fibers or yarns of cotton, polyester, rayon, silk, nylon or blends thereof. The cloth substrates can be provided as laminates with different substrate materials described herein. Paper substrates also can be saturated, barrier coated, pre-sized, backsized, untreated, or fiber-reinforced. The paper substrates also can be provided as laminates with a different type of substrate material. Polymeric substrates include polyolefin or polyester films. The polymeric substrates can be provided as blown film, or as laminates of different types of polymeric materials, or laminates of polymeric films with a non-polymeric type of substrate material. The substrate can also be a stem web used alone or incorporating a nonwoven, or as a laminate with a different type of substrate. The loop fabric substrate can be brushed nylon, brushed polyester, polyester stitched loop, and loop material laminated to a different type of substrate material. The foam substrate may be a natural sponge material or polyurethane foam and the like. The foam substrate also can be laminated to a different type of substrate material. The mesh substrates can be made of polymeric or metal open-weave scrims.

According to still other embodiments, the second substrate may have a particular thickness. For example, the second substrate may have a thickness of at least about 1 micron, such as, at least about 10 microns or at least about 20 microns or at least about 30 microns or at least about 40 microns or at least about 50 microns or at least about 60 microns or at least about 70 microns or at least about 80 microns or at least about 90 microns or at least about 100 microns or at least about 125 microns or at least about 150 microns or at least about 175 microns or at least about 200 microns or at least about 225 microns or even at least about 250 microns. According to still other embodiments, the second substrate may have a thickness of not greater than about 500 microns, such as not greater than about 450 microns or not greater than about 400 microns or even not greater than about 350 microns. It will be appreciated that the second substrate may have a thickness of any value between, and including, any of the minimum and maximum values noted above. It will be further appreciated that the second substrate may have a thickness within a range between, and including, any of the minimum and maximum values noted above.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. An aerogel-based layer comprising: a silicone-based binder component at a content of at least about 10 wt. % and not greater than about 90 wt. % for a total weight of the aerogel-based layer, and an aerogel component at a content of at least about 10 wt. % and not greater than about 90 wt. % for a total weight of the aerogel-based layer.

Embodiment 2. A composite material comprising: a first substrate, and an aerogel-based layer overlying a first surface of the first substrate, wherein the aerogel-based layer comprises: a silicone-based binder component at a content of at least about 10 wt. % and not greater than about 90 wt. % for a total weight of the aerogel-based layer, and an aerogel component at a content of at least about 10 wt. % and not greater than about 90 wt. % for a total weight of the aerogel-based layer.

Embodiment 3. An adhesive tape comprising: a first substrate, and an aerogel-based layer overlying a first surface of the first substrate, wherein the aerogel-based layer comprises: a silicone-based binder component at a content of at least about 10 wt. % and not greater than about 90 wt. % for a total weight of the aerogel-based layer, and an aerogel component at a content of at least about 10 wt. % and not greater than about 90 wt. % for a total weight of the aerogel-based layer.

Embodiment 4. A method of forming an aerogel-based layer, wherein the method comprises: providing a precursor mixture of a precursor silicone-based binder component and a precursor aerogel component, and forming the precursor mixture into the aerogel-based layer, wherein the aerogel-based layer comprises: a silicone-based binder component at a content of at least about 10 wt. % and not greater than about 90 wt. % for a total weight of the aerogel-based layer, and an aerogel component at a content of at least about 10 wt. % and not greater than about 90 wt. % for a total weight of the aerogel-based layer.

Embodiment 5. A method of forming a composite material, wherein the method comprises: providing a first substrate, providing a precursor mixture of a precursor silicone- based binder component and a precursor aerogel component, and forming the precursor mixture into the aerogel-based layer overlying a first surface of the first substrate, wherein the aerogel-based layer comprises: a silicone-based binder component at a content of at least about 10 wt. % and not greater than about 90 wt. % for a total weight of the aerogel-based layer, and an aerogel component at a content of at least about 10 wt. % and not greater than about 90 wt. % for a total weight of the aerogel-based layer.

Embodiment 6. A method of forming an adhesive tape, wherein the method comprises: providing a first substrate, providing a precursor mixture of a precursor silicone-based binder component and a precursor aerogel component, and forming the precursor mixture into the aerogel-based layer overlying a surface of the first substrate, wherein the aerogel-based layer comprises: a silicone-based binder component at a content of at least about 10 wt. % and not greater than about 90 wt. % for a total weight of the aerogel-based layer, and an aerogel component at a content of at least about 10 wt. % and not greater than about 90 wt. % for a total weight of the aerogel-based layer.

Embodiment 7. The aerogel-based layer, composite material, adhesive tape or method of any one of embodiments 1, 2, 3, 4, 5, and 6, wherein the aerogel-based layer comprises as shrinkage rating as measured at a firing temperature of 1000° C. of not greater than about 10%.

Embodiment 8. The aerogel-based layer, composite material, adhesive tape or method of any one of embodiments 1, 2, 3, 4, 5, and 6, wherein the aerogel-based layer comprises a thermal conductivity of not greater than about 0.05 W/m-K.

Embodiment 9. The composite material or method of any one of embodiments 2 and 5, wherein the composite material comprises a shrinkage rating as measured at a firing temperature of 1000° C. of not greater than about 10%.

Embodiment 10. The composite material or method of any one of embodiments 2 and 5, wherein the composite material comprises a thermal conductivity of not greater than about 0.05 W/m-K.

Embodiment 11. The adhesive tape or method of any one of embodiments 3 and 6, wherein the composite material comprises a shrinkage rating as measured at a firing temperature of 1000° C. of not greater than about 10%.

Embodiment 12. The adhesive tape or method of any one of embodiments 3 and 6, wherein the composite material comprises a thermal conductivity of not greater than about 0.05 W/m-K.

Embodiment 13. The aerogel-based layer, composite material, adhesive tape or method of any one of embodiments 1, 2, 3, 4, 5, and 6, wherein the aerogel-based layer comprises a silicone-based binder component content of at least about 15 wt. % for a total weight of the aerogel-based layer.

Embodiment 14. The aerogel-based layer, composite material, adhesive tape or method of any one of embodiments 1, 2, 3, 4, 5, and 6, wherein the aerogel-based layer comprises an aerogel component content of not greater than about 85 wt. % for a total weight of the aerogel-based layer.

Embodiment 15. The aerogel-based layer, composite material, adhesive tape or method of any one of embodiments 1, 2, 3, 4, 5, and 6, wherein the aerogel-based layer comprises an aerogel component content of at least about 15 wt. % for a total weight of the aerogel-based layer.

Embodiment 16. The aerogel-based layer, composite material, adhesive tape or method of any one of embodiments 1, 2, 3, 4, 5, and 6, wherein the aerogel-based layer comprises a silicone-based binder component content of not greater than about 85 wt. % for a total weight of the aerogel-based layer.

Embodiment 17. The aerogel-based layer, composite material, adhesive tape or method of any one of embodiments 1, 2, 3, 4, 5, and 6, wherein the aerogel-based layer further comprises an alkali silicate component.

Embodiment 18. The aerogel-based layer, composite material, adhesive tape or method of embodiment 17, wherein the aerogel-based layer comprises an alkali silicate component content of at least about 0.01 wt. % for a total weight of the aerogel-based layer.

Embodiment 19. The aerogel-based layer, composite material, adhesive tape or method of embodiment 17, wherein the aerogel-based layer comprises an alkali silicate component content of not greater than about 4.0 wt. % for a total weight of the aerogel-based layer.

Embodiment 20. The aerogel-based layer, composite material, adhesive tape or method of any one of embodiments 1, 2, 3, 4, 5, and 6, wherein the aerogel-based layer further comprises a thermal stabilizer component.

Embodiment 21. The aerogel-based layer, composite material, adhesive tape or method of embodiment 20, wherein the aerogel-based layer comprises a thermal stabilizer component content of at least about 0.01 wt. % for a total weight of the aerogel-based layer.

Embodiment 22. The aerogel-based layer, composite material, adhesive tape or method of embodiment 20, wherein the aerogel-based layer comprises a thermal stabilizer component content of not greater than about 30.0 wt. % for a total weight of the aerogel-based layer.

Embodiment 23. The aerogel-based layer, composite material, adhesive tape or method of any one of embodiments 1, 2, 3, 4, 5, and 6, wherein the aerogel-based layer further comprises an opacifier filler.

Embodiment 24. The aerogel-based layer, composite material, adhesive tape or method of embodiment 20, wherein the aerogel-based layer comprises an opacifier filler content of at least about 0.01 wt. % for a total weight of the aerogel-based layer.

Embodiment 25. The aerogel-based layer, composite material, adhesive tape or method of embodiment 20, wherein the aerogel-based layer comprises an opacifier filler content of not greater than about 30.0 wt. % for a total weight of the aerogel-based layer.

Embodiment 26. The aerogel-based layer, composite material, adhesive tape or method of any one of embodiments 1, 2, 3, 4, 5, and 6, wherein the first substrate comprises a woven structure.

Embodiment 27. The aerogel-based layer, composite material, adhesive tape or method of any one of embodiments 1, 2, 3, 4, 5, and 6, wherein the first substrate comprises a glass material, a wool material, a ceramic fabric material, a paper material, a fire-resistant paper material.

Embodiment 28. The aerogel-based layer, composite material, adhesive tape or method of any one of embodiments 1, 2, 3, 4, 5, and 6, wherein the aerogel-based layer has a thickness of at least about 1 micron.

Embodiment 29. The aerogel-based layer, composite material, adhesive tape or method of any one of embodiments 1, 2, 3, 4, 5, and 6, wherein the aerogel-based layer has a thickness of not greater than about 1999 microns.

Embodiment 30. The aerogel-based layer, composite material, adhesive tape or method of any one of embodiments 2, 3, 5, and 6, wherein the first substrate has a thickness of at least about 1 micron.

Embodiment 31. The aerogel-based layer, composite material, adhesive tape or method of any one of embodiments 2, 3, 5, and 6, wherein the first substrate has a thickness of not greater than about 500 microns.

Embodiment 32. The composite material or method of any one of embodiments 2 and 5, wherein the composite material further comprises a second substrate, and wherein the aerogel-based layer is between the first substrate and the second substrate.

Embodiment 33. The composite material or method of embodiment 32, wherein the second substrate comprises a woven structure.

Embodiment 34. The composite material or method of embodiment 32, wherein the second substrate comprises a glass material, a wool material, a ceramic fabric material, a paper material, a fire-resistant paper material.

Embodiment 35. The composite material or method of embodiment 32, wherein the second substrate has a thickness of at least about 1 micron.

Embodiment 36. The composite material or method of embodiment 32, wherein the second substrate has a thickness of not greater than about 500 microns.

Embodiment 37. The adhesive tape or method of any one of embodiments 3 and 6, wherein the composite material further comprises a second substrate, and wherein the aerogel-based layer is between the first substrate and the second substrate.

Embodiment 38. The adhesive tape or method of embodiment 37, wherein the second substrate comprises a woven structure.

Embodiment 39. The adhesive tape or method of embodiment 37, wherein the second substrate comprises a glass material, a wool material, a ceramic fabric material, a paper material, a fire-resistant paper material.

Embodiment 40. The adhesive tape or method of embodiment 37, wherein the second substrate has a thickness of at least about 1 micron.

Embodiment 41. The adhesive tape or method of embodiment 37, wherein the second substrate has a thickness of not greater than about 500 microns.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An aerogel-based layer comprising:
a silicone-based binder component at a content of at least about 10 wt. % and not greater than about 90 wt. % for a total weight of the aerogel-based layer, and
an aerogel component at a content of at least about 10 wt. % and not greater than about 90 wt. % for a total weight of the aerogel-based layer.

2. The aerogel-based layer of claim 1, wherein the aerogel-based layer comprises a shrinkage rating as measured at a firing temperature of 1000° C. of not greater than about 10%.

3. The aerogel-based layer of claim 1, wherein the aerogel-based layer comprises a thermal conductivity of not greater than about 0.05 W/m-K.

4. The aerogel-based layer of claim 1, wherein the composite material comprises a shrinkage rating as measured at a firing temperature of 1000° C. of not greater than about 10%.

5. The aerogel-based layer of claim 1, wherein the composite material comprises a thermal conductivity of not greater than about 0.05 W/m-K.

6. The aerogel-based layer of claim 1, wherein the composite material comprises a shrinkage rating as measured at a firing temperature of 1000° C. of not greater than about 10%.

7. The aerogel-based layer of claim 1, wherein the composite material comprises a thermal conductivity of not greater than about 0.05 W/m-K.

8. The aerogel-based layer of claim 1, wherein the aerogel-based layer comprises a silicone-based binder component content of at least about 15 wt. % for a total weight of the aerogel-based layer.

9. The aerogel-based layer of claim 1, wherein the aerogel-based layer comprises an aerogel component content of not greater than about 85 wt. % for a total weight of the aerogel-based layer.

10. The aerogel-based layer of claim 1, wherein the aerogel-based layer comprises an aerogel component content of at least about 15 wt. % for a total weight of the aerogel-based layer.

11. The aerogel-based layer of claim 1, wherein the aerogel-based layer comprises a silicone-based binder component content of not greater than about 85 wt. % for a total weight of the aerogel-based layer.

12. The aerogel-based layer of claim 1, wherein the aerogel-based layer further comprises an alkali silicate component.

13. The aerogel-based layer of claim 1, wherein the aerogel-based layer comprises an alkali silicate component content of at least about 0.01 wt. % for a total weight of the aerogel-based layer.

14. A composite material comprising:
a first substrate, and
an aerogel-based layer overlying a first surface of the first substrate, wherein the aerogel-based layer comprises:
a silicone-based binder component at a content of at least about 10 wt. % and not greater than about 90 wt. % for a total weight of the aerogel-based layer, and
an aerogel component at a content of at least about 10 wt. % and not greater than about 90 wt. % for a total weight of the aerogel-based layer.

15. The composite material of claim 14, wherein the aerogel-based layer comprises as shrinkage rating as measured at a firing temperature of 1000° C. of not greater than about 10%.

16. The composite material of claim 14, wherein the aerogel-based layer comprises a thermal conductivity of not greater than about 0.05 W/m-K.

17. The composite material of claim 14, wherein the composite material comprises as shrinkage rating as measured at a firing temperature of 1000° C. of not greater than about 10%.

18. The composite material of claim 14, wherein the composite material comprises a thermal conductivity of not greater than about 0.05 W/m-K.

19. The composite material of claim 14, wherein the composite material comprises as shrinkage rating as measured at a firing temperature of 1000° C. of not greater than about 10%.

20. An adhesive tape comprising:
a first substrate, and
an aerogel-based layer overlying a first surface of the first substrate, wherein the aerogel-based layer comprises:
a silicone-based binder component at a content of at least about 10 wt. % and not greater than about 90 wt. % for a total weight of the aerogel-based layer, and
an aerogel component at a content of at least about 10 wt. % and not greater than about 90 wt. % for a total weight of the aerogel-based layer.
